(19) United States
(12) Patent Application Publication
(10) Pub. No.: US 2012/0020722 A1
(43) Pub. Date: Jan. 26, 2012

(54) BUFFER MECHANISM

(76) Inventor: Chun-Chang TAI, Taichung County (TW)

(21) Appl. No.: 12/839,774

(22) Filed: Jul. 20, 2010

(51) Int. Cl. F16C 11/04

(52) U.S. Cl. 403/119

(57) ABSTRACT

A buffer mechanism of the present invention is adapted for a first object and a second object. The second object is pivotable about a pivoting axial with respect to the first object. The buffer mechanism includes an abutting member and a returning device. The abutting member is firmly disposed on one of the first object and the second object. The abutting member has a first abutting surface. The returning device includes a fixation member and a movable member. The fixation member is firmly disposed on the other one of the first object and the second object. The movable member is movable with respect to the fixation member between a first position and a second position. The movable member has a second abutting surface. The second abutting surface abuts against the first abutting surface. The movable member has a potential to return to the first position.

### BACKGROUND OF THE INVENTION

1. Field of the Invention

The present invention relates to a buffer mechanism, and more particularly to a buffer mechanism which is adapted for two pivotable objects.

2. Description of the Prior Art

In general, chairs, fitness equipment or rehabilitation equipment are usually installed buffer mechanisms. The buffer mechanisms are used for supporting or recovering the equipment, or the buffer mechanisms may be used as a damper. For example, springs or pneumatic cylinders usually connect the back of a chair to the seat to provide the functions above. In this case, the springs or the pneumatic cylinders are installed with pins or threaded pieces. Therefore, the springs or the pneumatic cylinders are pivotable with respect to the chairs.

However, these chairs are not easy to be produced. To fabricate the pins or threaded pieces, the components or the chair have to be positioned and bored for many times. Secondly, the pins or the threaded pieces may probably hinder the back of a chair from pivoting. Thirdly, the buffer mechanisms pivot during the pivoting of the back of a chair, so that the buffer mechanisms may probably harm a user seriously by clamping the user's body.

The present invention is, therefore, arisen to obviate or at least mitigate the above mentioned disadvantages.

### SUMMARY OF THE INVENTION

The main object of the present invention is to provide another buffer mechanism to mitigate the disadvantages above.

To achieve the above and other objects, a buffer mechanism of the present invention is provided to be disposed between a first object and a second object. The second object is rotatable about a pivoting axial with respect to the first object. The buffer mechanism includes an abutting member and a returning device. The abutting member is firmly disposed on one of the first object and the second object. The abutting member has a first abutting surface. The returning device includes a fixation member and a movable member. The fixation member is firmly disposed on the other one of the first object and the second object. The movable member is movable with respect to the fixation member between a first position and a second position. The movable member has a second abutting surface. The second abutting surface abuts against the first abutting surface. The movable member has a potential to return to the first position. The movable member is moved by the abutting member toward the second position when the first object and the second object pivot with respect to each other by an external force. The movable member is spontaneously returnable to the first position after the external force is removed, so that the first object and the second object pivot to their original position.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing showing a first embodiment of the present invention;

FIG. 2 is a lateral view showing a first embodiment of the present invention, wherein the movable member is located in the first position;

FIG. 3 is a lateral view showing a first embodiment of the present invention, wherein the movable member is located in the second position;

FIG. 4 is a breakdown drawing showing a second embodiment of the present invention;

FIG. 5 is a lateral view showing a third embodiment of the present invention;

FIG. 6 is a lateral view showing a forth embodiment of the present invention;

FIG. 7 is a lateral view showing a forth embodiment of the present invention.

### DETAILED DESCRIPTION OF THE PREFERRED EMBODIMENTS

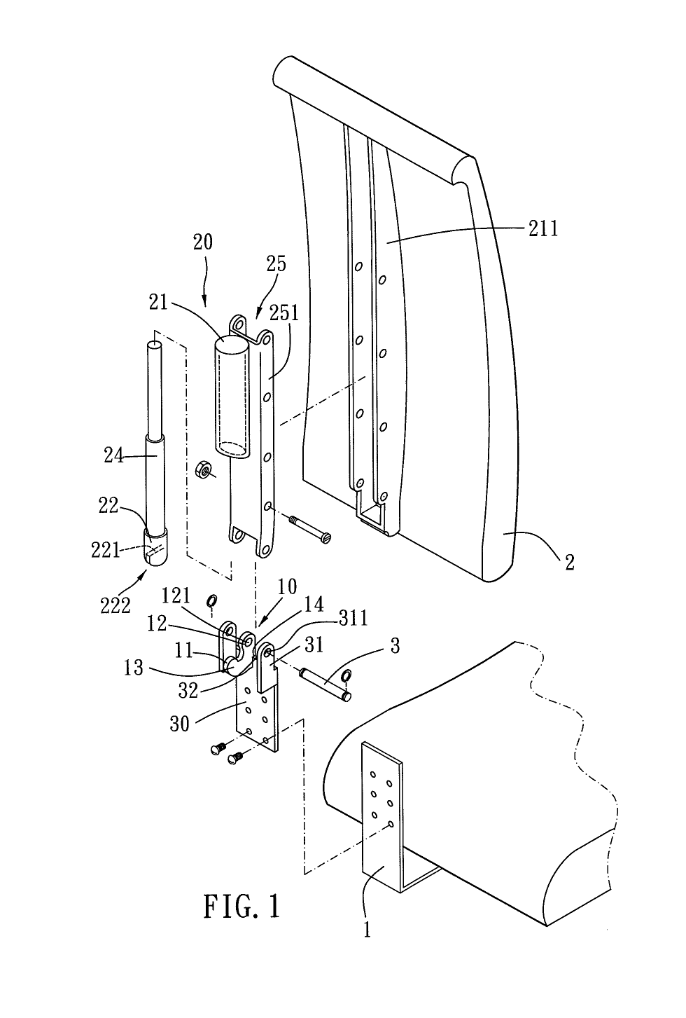

Please refer to FIG. 1 for a first embodiment of the present invention. The buffer mechanism of the present embodiment is adapted for being disposed between a first object 1, such as a seat or a plate disposed on a seat as shown in FIG. 1, and a second object 2, such as a back of a chair. The second object 2 is pivotable with respect to the first object 1 about a pivoting axial 3. The buffer mechanism includes an abutting member 10, a recovering device 20 and a positioning device 30.

The abutting member 10 is firmly disposed on one of the first object 1 and the second object 2. The abutting member 10 has a first abutting surface 11. More specifically, the abutting member 10 is hook-shaped. The abutting member 10 has a pivoting portion 12 and an abutting portion 13. The pivoting portion 12 is formed with a through hole 121. The first abutting surface 11 is located on the abutting portion 13.

The positioning device 30 is adapted for fixing the abutting member 10. For the reason, the positioning device 30 is firmly disposed on the corresponding one of the first object 1 and the second object 2. The plate-formed positioning device 30 includes two supporting arms 31 and a linking section 32. The supporting arms 31 are located on the top end of the positioning device 30. The linking section 32 connects between the supporting arms 31. A containing space is defined by the supporting arms 31 and the linking section 32. The supporting arm 31 is formed with an axial hole 311. The abutting member 10 is located in the containing space. The abutting member 10 abuts against the linking section 32. The pivoting axial 3 is received in the axial holes 311 and the through hole 121, so that the abutting member 10 is fixed on the positioning device 30. In other possible embodiments of the invention, the abutting member 10 may be directly disposed on one of the first object 1 and the second object 2 without the positioning device 30.

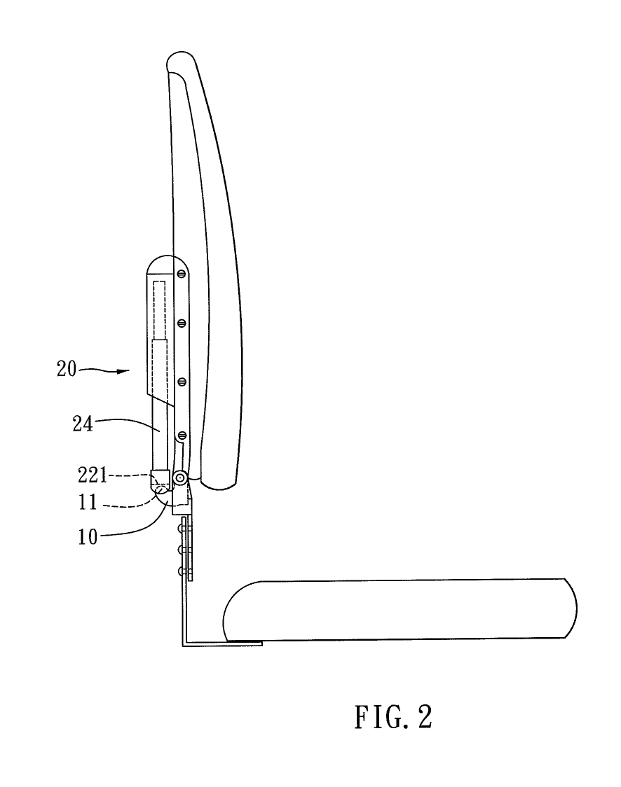

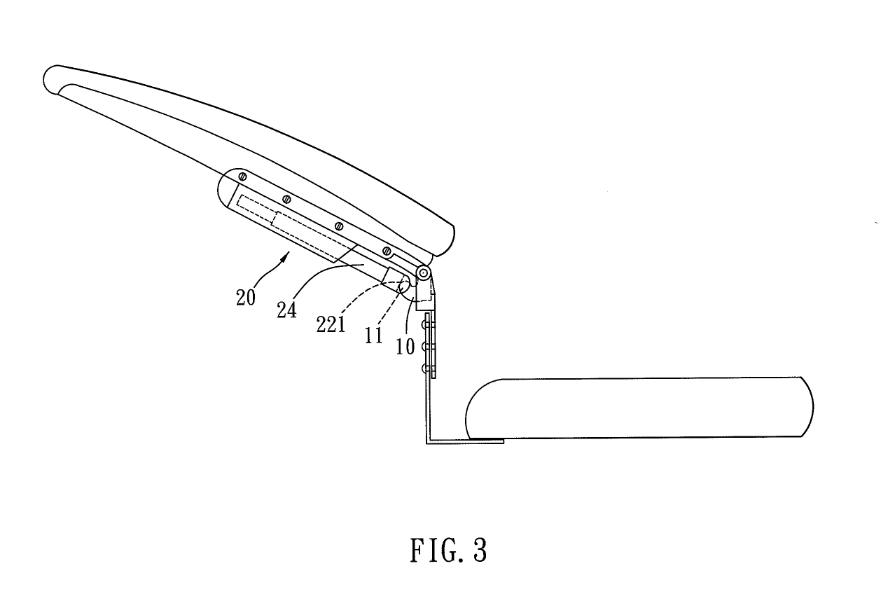

The recovering device 20 includes a fixation member 21 and a movable member 22. Both the fixation member 21 and the movable member 22 are hollow tubes. The movable member 22 is received in the fixation member 21 from a bottom end of the fixation member 21. The fixation member 21 is firmly disposed on the other one of the first object 1 and the second object 2. The movable member 22 is movable with respect to the fixation member 21 between a first position and a second position. The movable member 22 has a second abutting surface 221. The second abutting surface 211 abuts slidably against the first abutting surface 11. The movable member 22 has a potential to return to the first position. Preferably, one end of the movable member 22 is formed with a guiding groove 222, as shown in FIG. 1. The second abutting surface 221 is located on the bottom of the guiding groove 222. The first abutting surface 11 is convex. Therefore, the abutting surfaces 11, 221 slide with respect to each other during the pivot of the second object 2 with respect to the first object 1, as shown in FIG. 2 and FIG. 3. In other possible embodiments of the present invention, the second abutting surface 221 may be a plane. Besides, one of the first abutting surface 11 and the second abutting surface 221 is convex, and the other one is concave. Thus, the first abutting surface 11 and the second abutting surface 221 slide with respect to each other during the pivot of the second object 2 with respect to the first object 1.

To obtain the potential above, a resilient member, such as a spring (not shown), or a piston device 24, such as a pneumatic cylinder, may be disposed between the fixation member 21 and the movable member 22. Preferably, an inner space is defined by the fixation member 21 and the movable member 22, and the piston device 24 is located in the inner space.

To fix the fixation member, the fixation member 21 may include a u-shaped member 211 and an n-shaped member 25. The u-shaped member 211 may be firmly disposed on the second object 2 or the first object 1. The n-shaped member 25 may be welded on the u-shaped member 211. The n-shaped member 25 has two side plates 251, which is formed with plurality of bolt holes. The bolt holes are adapted for the u-shaped member 211 to be fixed thereon by several bolts. Thus, the positioning device can be firmly disposed on the second object 2. The bottom end of the n-shaped member 25 is formed with axial holes, which is adapted for the pivoting axial 3 to penetrate therethrough. The bottom end of the abutting member 10 is formed with a step surface 14. The step surface 14 abuts against the top end of the linking section 32. Besides, the step surface 14 may be welded on the linking section 32. Thus, the abutting member 10 is supported by the supporting arms 31 and the linking section 32, so that the buffer mechanism is strengthen.

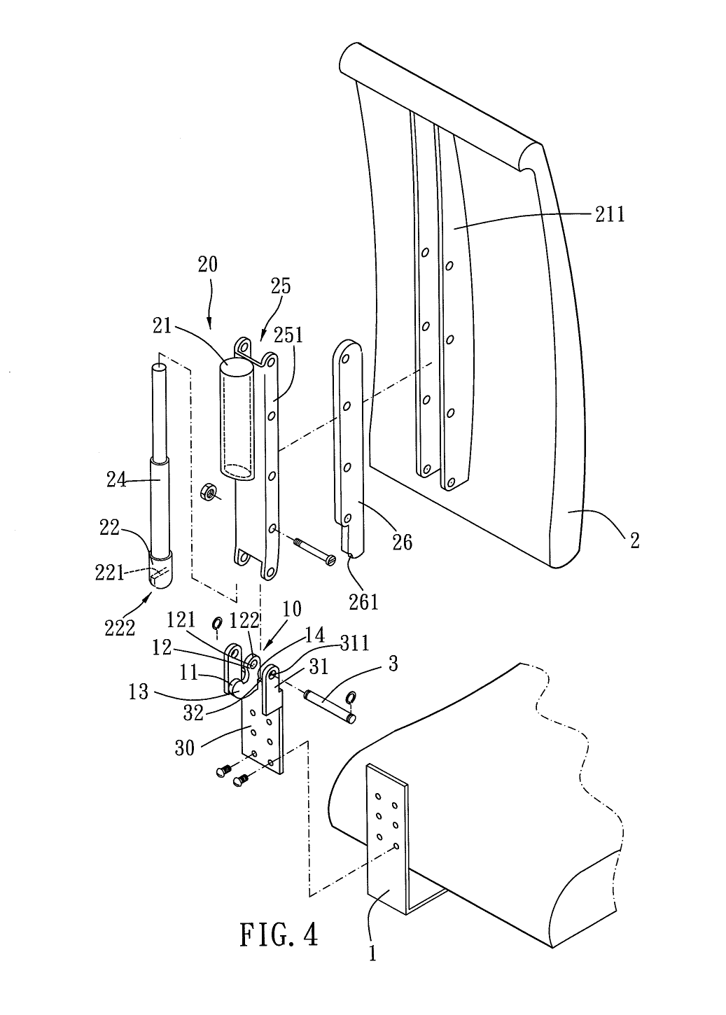

Please refer to FIG. 4 for a second embodiment of the present invention. A fixing plate 26 may be disposed between the u-shaped member 211 and the n-shaped member 25. The bottom end of the fixing plate 26 is formed with an arc surface 261. The abutting member has a cambered surface 122. When the movable member 22 is located on the first position, the arc surface 261 abuts against the cambered surface 122. Thus, the second object 2 can be supported. The position of the second object 2 can be determined by the curvature of the arc surface 261.

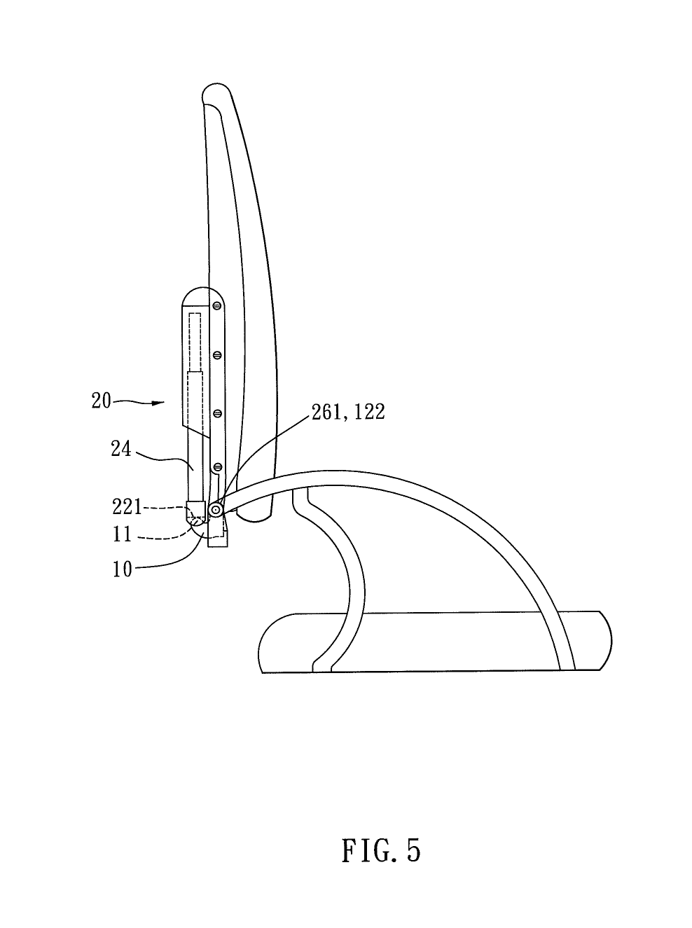

Please refer to FIG. 5. In another embodiment of the present invention, the positioning device 30 and the abutting member 10 may be disposed on an armrest of the chair.

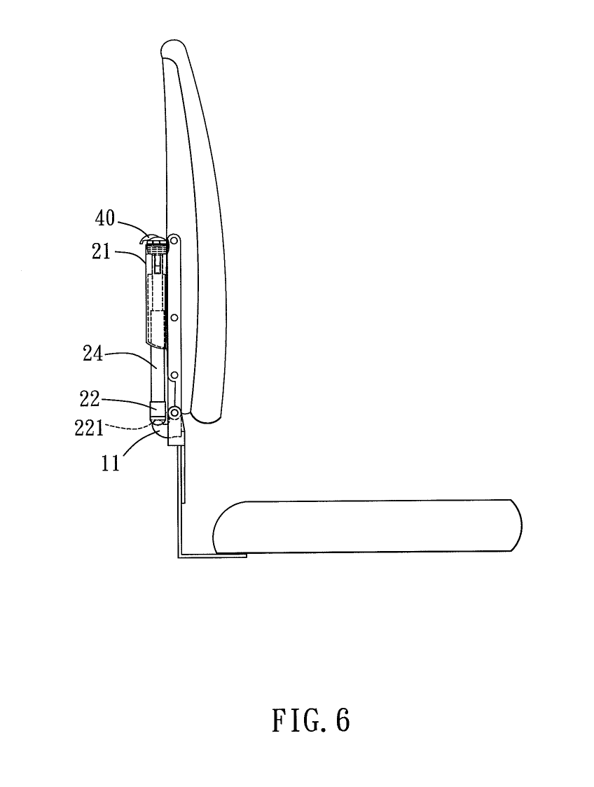

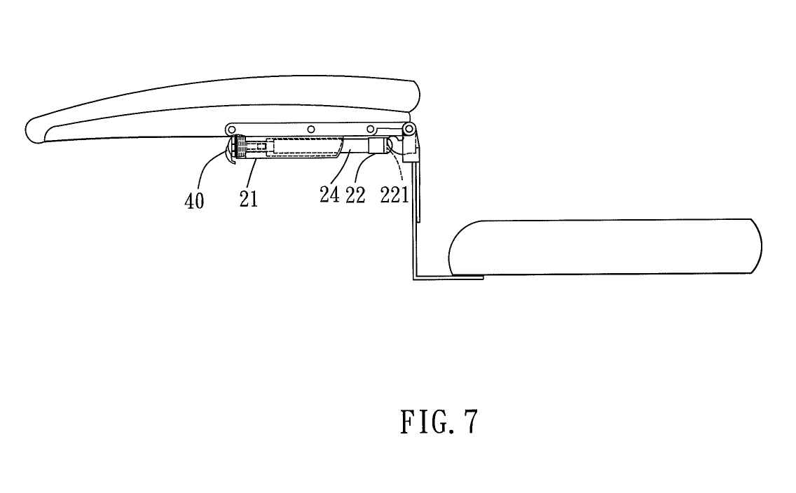

Please refer to FIG. 6 and FIG. 7. A rotatable controlling member 40 may be disposed on the top end of the fixation member 21. The controlling member 40 is a controller of the piston device 24. The air in the piston device 24 can be controlled by the controlling member 40 whether it is releasable or not.

Accordingly, the present invention provides several advantages. Firstly, the buffer mechanism is simplified and is easy to be fabricated on a chair. The resilient member or the piston device can be disposed in the inner space without fixation. Secondly, the movable member abuts against the abutting member directly. There is no blot or screw between the movable member and abutting member, so that the pivot of the first object and the second object is unhindered. Thirdly, the piston device or the resilient member remains parallel to the fixation member during the pivot of the first object or the second object. Thus, the possibility of clamping user's body by the piston device or the resilient member is minimized.

The buffer mechanism of the present invention is adapted for a chair, being disposed between the seat and the back of the chair. When the chair includes several pads, the buffer mechanism can also be disposed between the pads. In other possible embodiments of the present invention, the buffer mechanism can also be installed in fitness equipment or rehabilitation equipment to provide the functions above.

What is claimed is:

1. A buffer mechanism, disposed between a first object and a second object,
said second object being rotatable about a pivoting axial with respect to said first object, the buffer mechanism comprising:
an abutting member, firmly disposed on one of the first object and the second object, the abutting member having a first abutting surface;
a returning device, comprising a fixation member and a movable member, the fixation member being firmly disposed on the other one of the first object and the second object, the movable member being movable with respect to the fixation member between a first position and a second position, the movable member having a second abutting surface, the second abutting surface abutting against the first abutting surface, the movable member having a potential to return to the first position;
wherein the movable member is moved by the abutting member toward the second position when the first object and the second object pivot with respect to each other by an external force;
wherein the movable member is spontaneously returnable to the first position after the external force is removed, so that the first object and the second object pivot to their original position.

2. The buffer mechanism of claim 1, wherein the abutting member has a pivoting portion and a abutting portion, the pivoting portion is formed with a through hole, the first abutting surface is located on the abutting portion, the through hole is adapted for the pivoting axial to be received therein.

3. The buffer mechanism of claim 2, further comprising a positioning device, the positioning device being firmly disposed on one of the first object and the second object, the positioning device comprising two supporting arms and a linking section, the linking section connecting between the supporting arms, a containing space being defined by the supporting arms and the linking section, each supporting arm being formed with a axial hole, the pivoting axial being received in the axial holes and the through hole, the abutting member being disposed in the containing space, the abutting member having a step surface located on the bottom end thereof, the step surface abutting against the linking section.

4. The buffer mechanism of claim 1, wherein a resilient member is disposed between the fixation member and the movable member, the resilient member provides the potential for returning the movable member to the first position.

5. The buffer mechanism of claim 1, wherein a piston device is disposed between the fixation member and the movable member, the piston device provides the potential for returning the movable member to the first position.

6. The buffer mechanism of claim 1, further comprising an n-shaped member, a u-shaped member and a fixing plate, the n-shaped member being adapted for the fixation member to be disposed thereon, the u-shaped member connecting the n-shaped member to one of the first object and the second object, the fixing plate being disposed between the n-shaped member and the u-shaped member, the n-shaped member having two side plates, the bottom ends of the side plates being adapted for the pivoting axial to penetrate therethrough, the fixing plate having an arc surface located on the bottom end thereof, the abutting member having a cambered surface, the arc surface abutting against the cambered surface when the movable member is located on the first position.

7. The buffer mechanism of claim 1, wherein one of the first abutting surface and the second abutting surface is convex, the other one of the first abutting surface and the second abutting surface is concave, the first abutting surface and the second abutting surface slide with respect to each other during the pivot of the second object with respect to the first object.

8. The buffer mechanism of claim 1, wherein the movable member is formed with a guiding groove, the second abutting surface is located on the bottom of the guiding groove, the first abutting surface is convex, the first abutting surface and the second abutting surface slide with respect to each other during the pivot of the second object with respect to the first object.
